(19) United States
(12) Patent Application Publication
(10) Pub. No.: US 2019/0328026 A1
(43) Pub. Date: Oct. 31, 2019

(54) SMALL BATCH ROASTER

(71) Applicant: IA Collaborative Ventures, LLC - Series Kelvin, Chicago, IL (US)

(72) Inventors: Luke A. Westra, Chicago, IL (US); Daniel M. Kraemer, Chicago, IL (US); Patrick Thomas Jones, Chicago, IL (US); Sean J. Sanders, Chicago, IL (US); Luis Humberto Velazquez Rascon, San Francisco, CA (US); Derek Ashley Smith, Chicago, IL (US)

(73) Assignee: IA Collaborative Ventures, LLC - Series Kelvin, Chicago, IL (US)

(21) Appl. No.: 16/510,230

(22) Filed: Jul. 12, 2019

Related U.S. Application Data
(63) Continuation-in-part of application No. PCT/US2018/013336, filed on Jan. 11, 2018.

(51) Int. Cl. A23N 12/10; A23N 12/08

(52) U.S. Cl. CPC A23N 12/10; A23F 5/04; A23N 12/083

(57) ABSTRACT

A small batch roasting device including a base unit and a roasting chamber unit. The base unit includes a housing, a heating element, a fan, and a support surface. The housing defines an upper end, a lower end, and an isolation chamber open to the upper end. The heating element and the fan are within the housing, with the fan being positioned between the heating element and the lower end. The roasting chamber unit defines a roasting chamber, a leading region and a trailing region terminating at a trailing end. In an assembled state, a portion of the roasting chamber unit is disposed within the isolation chamber and the trailing portion is proximate the heating element. The roasting chamber unit is supported relative to the base unit by an interface with the support surface at a location longitudinally spaced from the trailing end.

### CROSS-REFERENCE TO RELATED APPLICATIONS

This application is a continuation of International Application No. PCT/US2018/13336, filed Jan. 11, 2018 which claims the benefit of the filing date of U.S. Provisional Patent Application Ser. No. 62/445,454, filed Jan. 12, 2017, entitled “SMALL BATCH ROASTER,” the entire teachings of each are incorporated herein by reference.

### BACKGROUND

The present disclosure relates to table top or small batch roasting of consumable products, such as coffee beans. More particularly, it relates to convenient, simple to operate, small batch roasting devices for roasting coffee beans and other consumable products.

Coffee has become an increasingly vital component of modern society. One often overlooked problem is that while unroasted green coffee beans have a shelf-life of many months, the coffee beans begin degrading as soon as they are roasted. This degradation occurs as the volatile organic chemical compounds that create the aromas and flavors of the coffee start to break down. A consumer desiring to brew the freshest tasting coffee needs to either use the freshest roasted bean or they need to store roasted beans under ideal conditions. These ideal storage conditions generally require elaborate mechanisms for reducing or eliminating the exposure of the roasted coffee beans to light and oxygen during storage. Commercial roasters solve this problem by storing coffee in opaque packaging that is flush with an inert gas (e.g., Nitrogen) prior to sealing the package. At home consumers typically do not have access to these ideal storage conditions. Instead, home consumers desiring to obtain the freshest product normally must patronize a local coffee shot that roast coffee beans in-house, either buying brewed coffee from the shop every day, or buying roasted coffee beans in a small enough amount that they will not significantly degrade before being consumed.

Industrial-type, large batch coffee bean roasters are simply too large and expensive for home consumers. While efforts have been made to devise small batch coffee bean roasters more readily suited for in-home use, available small batch coffee bean roasters are too complex, too expensive, require too much time to roast, and/or occupy too much counter space for the average coffee drinker.

### SUMMARY

The inventors of the present disclosure have recognized that a need exists for small batch roasting devices that overcome one or more of the above-mentioned problems.

Some aspects of the present disclosure are directed to a small batch roasting device. The roasting device includes a base unit and a roasting chamber unit. The base unit includes a housing, a heating element, a fan, and a support surface. The housing defines an upper end, a lower end opposite the upper end, and an isolation chamber open to the upper end. The heating element and the fan are maintained within the housing, with the fan being positioned between the heating element and the lower end. The support surface is formed at a location longitudinally spaced from the lower end. The roasting chamber unit defines a roasting chamber, a leading region and a trailing region opposite the leading region, with the trailing region terminating in a trailing end. The roasting device is configured to provide an assembled state in which at least a portion of the roasting chamber unit is disposed within the isolation chamber and the trailing portion is proximate the heating element. In the assembled state, the roasting chamber unit is supported relative to the base unit by an interface between the roasting chamber unit and the support surface of the base unit. In this regard, the roasting chamber unit is longitudinally supported relative to the base unit at a location longitudinally spaced from the trailing end of the roasting chamber unit. With this construction, the roasting chamber unit can be removed from (and re-inserted into) the base unit, with the trailing region hanging near the heating element. In some embodiments, the base unit further includes a controller (e.g., a timer) that operates to prompt operation of the heating element and the fan in a pre-determined fashion (e.g., operating the heating element and the fan for a first time period as part of a roasting cycle, followed by operating only the fan for a second time period as part of a cooling cycle). In related embodiments, the base unit is configured such that user interface or input to the controller is provided by a single control knob. In yet other embodiments, the housing of the base unit includes a transparent segment forming at least a portion of the isolation chamber, affording a user the ability to view the roasting chamber unit while assemble to the base unit during a roasting operation.

Other aspects of the present disclosure are directed to a small-batch coffee roaster that allows a user to roast green coffee beans when they are needed to allow the consumption of the freshet roasted coffee possible. In some embodiments, the roasting process is achieved with a simple, single-knob interface that controls roast time, while the device automatically sets the roasting temperature and provides an automatic cooling mode at the completion of the roasting time. In other embodiments, the device can control the heater to generate a specific temperature profile during the roasting cycle. In yet other embodiments, the device is configured such that a user can manually select the roasting temperature and/or roasting temperature profile.

### BRIEF DESCRIPTION OF THE DRAWINGS

FIG. 1A is an exploded, perspective view of a roasting device in accordance with principles of the present disclosure;

FIG. 1B is a perspective view of the roasting device of FIG. 1A in an assembled state;

FIG. 2 is an exploded, perspective view of a base unit in accordance with principles of the present disclosure and useful with the roasting device of FIG. 1A;

FIG. 3 is an enlarged, perspective view of a portion of the base unit of FIG. 2 upon final assembly;

FIGS. 4A-4C are enlarged, perspective view of a portion of the base unit of FIG. 2 and illustrating arrangements of a control knob relative to an indicator;

FIG. 5 is an perspective, bottom view of a floor assembly of the base unit of FIG. 2;

FIG. 6 is a perspective view of a shroud of the base unit of FIG. 2;

FIG. 7A is a cross-sectional view of a portion of the base unit of FIG. 2 with components omitted;

FIG. 7B is a cross-sectional view of a portion of the base unit of FIG. 2 upon final assembly;

FIG. 8 is a simplified, cross-sectional view of a portion of an alternative base unit in accordance with principles of the present disclosure;

FIG. 9 is an exploded, perspective view of a roasting chamber unit in accordance with principles of the present disclosure and useful with the roasting device of FIG. 1A;

FIG. 10 is an enlarged, cross-sectional view of a container of the roasting chamber unit of FIG. 9;

FIG. 11 is an enlarged, cross-sectional view of a filter of the roasting chamber unit of FIG. 9;

FIG. 12 is an exploded, perspective view of a cap of the roasting chamber unit of FIG. 9;

FIG. 13 is a bottom perspective view of a cap member of the cap of FIG. 12;

FIG. 14 is a cross-sectional view of the roasting chamber unit of FIG. 9;

FIGS. 15A and 15B are cross-sectional views of the roasting device of FIG. 1A and illustrating assembly of the roasting chamber unit to the base unit;

FIG. 16A is a perspective view of a cartridge useful with the roasting devices of the present disclosure;

FIG. 16B is a bottom perspective view of the cartridge of FIG. 16A;

FIG. 16C is a perspective view of a container of the cartridge of FIG. 16A;

FIG. 17A is a perspective view of a roasting chamber unit in accordance with principles of the present disclosure;

FIG. 17B is a top perspective view of a container of the roasting chamber unit of FIG. 17A;

FIG. 17C is a side perspective view of the container of FIG. 17B;

FIG. 18A is an exploded, perspective view of a roasting device in accordance with principles of the present disclosure;

FIG. 18B is a perspective view of the roasting device of FIG. 18A in an assembled state;

FIG. 19 is a cross-sectional view of a base unit of the roasting device of FIG. 18A;

FIG. 20A is a cross-sectional view of the roasting device of FIG. 18A in the assembled state of FIG. 18B; and

FIG. 20B is an enlarged view of a portion of the cross-section of FIG. 20A.

### DETAILED DESCRIPTION

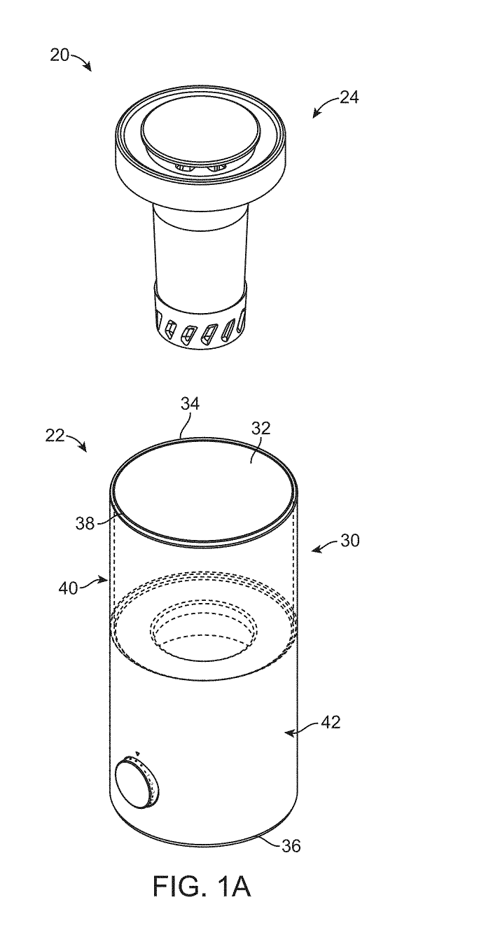

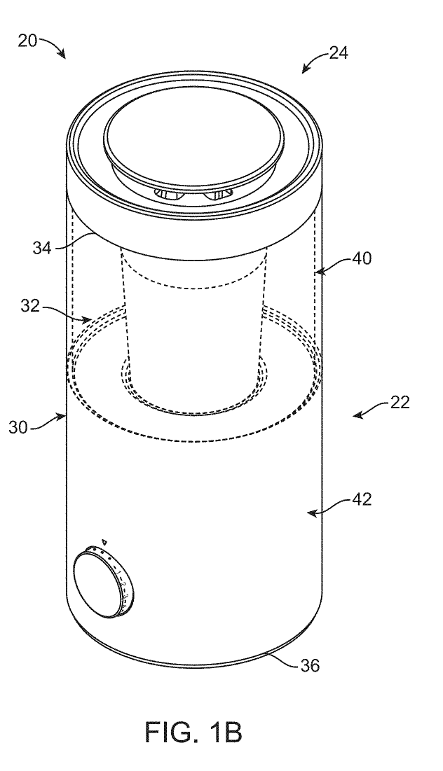

One embodiment of a small batch roasting device 20 in accordance with principles of the present disclosure is shown in FIGS. 1A and 1B. The roasting device 20 includes a base unit 22 and a roasting chamber unit 24. Details on the various components are provided below. In general terms, the roasting chamber unit 24 is selectively mountable to the base unit 22, with a user readily transitioning the roasting device 20 between a product load/unload state (FIG. 1A) and an assembled state (FIG. 1B). In the product load/unload state, product (not shown), such as coffee beans, can be loaded into or removed from a chamber of the roasting chamber unit 24. In the assembled state, the roasting chamber unit 24 is mounted to the base unit 22, with the base unit 22 including components operable to heat the roasting chamber unit 24 (and product loaded therein) as selected by a user. As the contained product is heated (or roasted), features of the base unit 22 protect against inadvertent contact with hot surfaces of the roasting chamber unit 24. Following completion of the roasting cycle (the timing and temperatures of which can be pre-programmed to the base unit 22), the roasting chamber unit 24 is readily removed from the base unit 22 (i.e., the product load/unload state of FIG. 1A), and the now-roasted product dispensed from the roasting chamber unit 24. The roasting devices of the present disclosure are easy to operate in small batch roasting of coffee beans and similar consumable products, and are conveniently located on a table top or other available surface in a consumer's home or work place. In some non-limiting embodiments, the roasting process is achieved with a simple, single-knob interface that controls roast time, while the device 20 automatically sets the roasting temperature and provides an automatic cooling mode at the completion of the roasting time.

The base unit 22 can assume a variety of forms, and includes a housing 30. The housing 30 is generally configured to maintain various other components of the base unit 22 as described below, as well as to establish an isolation chamber 32 (referenced generally in FIG. 1A) within which at least a portion of the roasting chamber unit 24 is located in the assembled state. In this regard, the housing 30 can be described as defining or extending between a first or upper end 34 and a second or lower end 36. With the non-limiting example of FIGS. 1A and 1B, the upper end 34 serves as a support surface of the base unit 22 as described below, with the support surface thus being defined by an upper-most end of the housing 30; in other embodiments, the support surface of the base unit is longitudinally off-set from the upper-most end of the housing 30 as described below. An opening 38 to the isolation chamber 32 is defined at the upper end 34. In some embodiments, the housing 30 is formed or defined by two (or more) housing segments, such as a first housing segment 40 mounted to a second housing segment 42. The first housing segment 40 forms at least a majority of the isolation chamber 32, and defines, or carries another housing segment that defines, the upper end 34. The second housing segment 42 extends from the first housing segment 40 to the lower end 36, and houses various other components of the base unit 22. With these conventions in mind, the first and second housing segments 40, 42 can be formed of differing materials. For example, the first housing segment 40 can be formed of a transparent or nearly transparent material, optionally exhibiting thermal insulation properties. Some exemplary materials for the first housing segment 40 include glass, plastic, etc. With this construction, a user can see “through” the first housing segment 40 and thus view the roasting chamber unit 24 while located within the isolation chamber 32 (as in FIG. 1B); further, heat within the isolation chamber 32 is not readily conducted through a thickness of the first housing segment 40 serving to minimize injury in the event a user inadvertently contacts the first housing segment 40 during a roasting cycle. The second housing section 42 can be formed of an opaque material that optionally exhibits thermal insulation properties, such as stainless steel, aluminum, etc. The second housing section 42 can have a single wall design; alternatively, the second housing section 42 can be made from a dual-walled construction, allowing for vacuum insulation to keep the exterior wall(s) cooler during a roasting operation. In other embodiments, the second housing section 42 can utilized a dual wall construction whereby the interior is a separate, temperature insulating material such as foam. In yet other embodiments, the housing 30 can have a more homogenous construction. With embodiments in which the first and second housing segments 40, 42 are constructed of different materials and/or as two separate components, the housing segments 40, 42 can be coupled to one another via various mechanical connections as known in the art including, but not limited to, sliding fits, magnets, threads, etc.

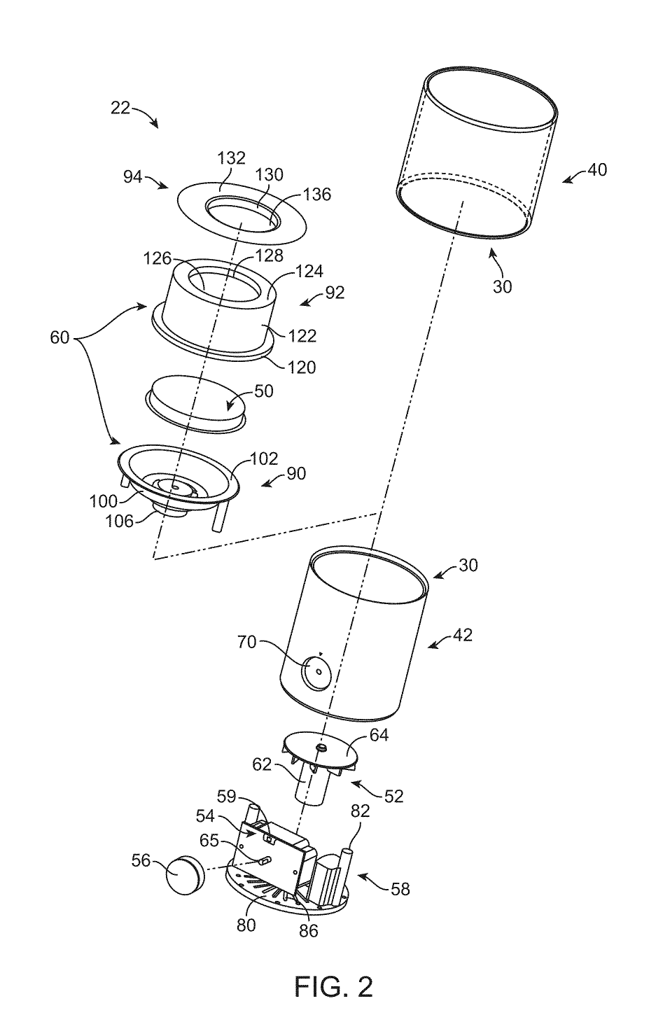

With reference to FIG. 2, in addition to the housing 30 (e.g., the housing segments 40, 42), the base unit 22 can include a heating element 50 (drawn schematically), a fan assembly 52, a controller 54, a control knob 56, a floor assembly 58, and an air flow assembly 60. In general terms, the heating element 50 and the fan assembly 52 (as well as other optional components, such as a light source 59) are electrically connected to the controller 54, with the controller 54 being programmed to control or regulate operation of the heating element 50 and the fan assembly 52 (e.g., by activating or deactivating the delivery of power to the heating element 50 and/or the fan assembly 52 from a power source (not shown)) in a pre-determined or timed fashion. The control knob 56 provides a user interface with the controller 54. The floor assembly 58 is mounted to the housing 30, and supports at least the fan assembly 52, the air flow assembly 60 (that in turn supports the heating element 50), an optionally the controller 54. As described below, the air flow assembly 60 is configured to contain and direct air flow (as generated by the fan assembly 52) in a desired manner for interfacing with the roasting chamber unit 24 (FIG. 1A).

The heating element 50 can assume various forms appropriate for generating heat at temperatures appropriate for roasting green coffee beans (or other consumable product of interest), for example a temperature on the order of 350-500° F. In some embodiments, the heating element 50 can be or can include a one or more electrical resistance heating coils or similar resistance-type elements, ceramic heating element, etc. Other conventional heating element formats are also acceptable.

The fan assembly 52 can be a motorized fan as is known in the art, and includes a motor 62 and fan blades or impeller 64. The motor 62 can be an electrically-powered motor, operable to rotate the impeller 64. The impeller 64 can also be of a conventional design, generating air flow when rotated. Alternatively, the impeller 64 can incorporate one or more blade shapes differing from the shapes implicated by the Figures in such a way as to provide specific types of airflow and therefore product movement within roasting chamber unit 24 as described in greater detail below.

The controller 54 includes appropriate logic or electrical component circuitry (e.g. a programmable logic controller, timer, etc.) for independently controlling operation of the heating element 50 and the fan assembly 52 according to the operational protocols or algorithms described below. In some embodiments, the controller 54 can include a memory component for storing the operational instructions or algorithms. Further, the controller 54 is configured to receive and act upon user information inputted via the control knob 56. Thus, the controller 54 can include a rotatable shaft 65 to which the control knob 56 is mounted; the shaft 65 rotates with rotation of the control knob 56, with the controller 54 optionally configured to operate in response to a rotational position of the shaft 65 (e.g., the controller 54 can include one or more sensors for sensing a rotational position of the shaft 65, a variable contact switch that the shaft 65 selectively interacts with, etc.). Further, the controller 54 is configured or programmed to rotate the shaft 65, and thus the control knob 56, in a controlled fashion (e.g., incrementally rotating the shaft 65/control knob 56 throughout a roasting cycle). The controller 54 can further include or maintain other electrical components, such as the light source (e.g., LED) 59 for reasons described below. In some alternative embodiments, the controller 54 can include wireless communication components (e.g., a wireless receiver or transreceiver) for wirelessly receiving information from, or outputting information to, a user. The controller 54 can be maintained or supported relative to the housing 30 in various manners, such as by attachment to the housing 30, attachment to the floor assembly 58, etc.

As implicated above, user-prompted operation of the base unit 22 in performing a roasting operation is performed via the control knob 56. In some embodiments, the control knob 56 is the only user input element provided with the roasting devices of the present disclosure. With this in mind, FIG. 3 is an enlarged view of a portion of the base unit 22 upon final assembly. As shown, the control knob 56 is accessible from an exterior of the housing 30, for example rotatably nested within a recess 70 (best shown in FIG. 2) formed by the housing 30. In some non-limiting examples, the control knob 56 optionally displays indicia 72 (referenced generally). The indicia 72 can assume various forms, and in some embodiments is selected to convey to a user one or more of roasting cycle time, roasting “level”, and roasting cycle stage or operation. For example, the indicia 72 can include roast time designators 74 (e.g., numbers) that generally indicate roasting time or “level” of roasting. In the non-limiting example of FIG. 3, the roast time designators 74 are numbers “1”, “2”, “3”, etc., and can be indicative of time (e.g., hours). The indicia 72 can further include cycle designators 76, such as the symbol “*” as in FIG. 3. The cycle designators 76 can differ from the roast time designators 74, implicating to a viewer that the roasting device 20 is operating in a non-roasting mode (e.g., a cooling mode).

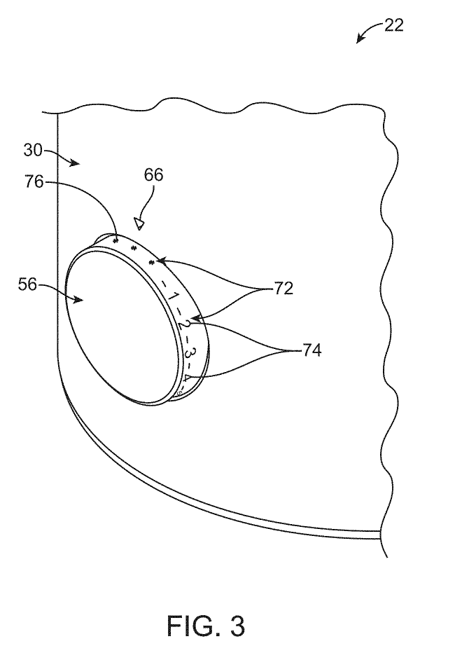

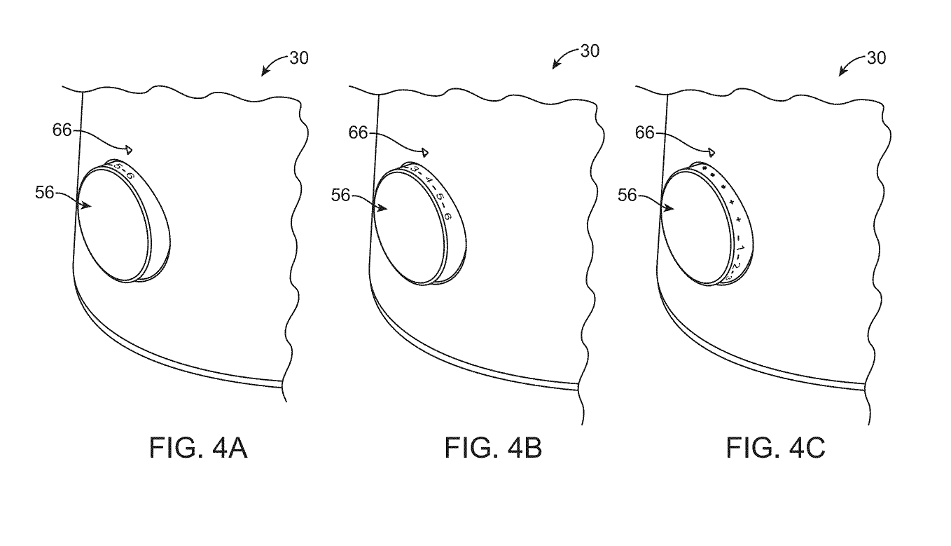

FIG. 3 further illustrates that in some non-limiting examples, an indicator 66 as visible from an exterior of the housing 30 in fixed, close proximity to the control knob 56. With this arrangement, the indicator 66 correlates with the control knob indicia 72, conveying to a user the particular operational setting of the roasting device 20. With additional reference to FIG. 2, the light source 59, where provided, is aligned with the indicator 66 (e.g., when the light source 59 is powered on, the indicator 66 is illuminated). For example, in the control knob 56 arrangement of FIG. 3, a middle one of the cycle indicators 76 is generally aligned with the indicator 66 (e.g., the indicator 66 is “pointing” to the middle cycle indicator 76). The controller 54 (FIG. 2) is programmed to correlate a rotational position of the control knob 56 relative to the housing 30 (and thus of the indicia 72 relative to the indicator 66) with a current operational setting or parameter of the roasting device 20. By way of further example, FIG. 4A illustrates another rotational arrangement of the control knob 56 relative to the housing 30, with the roast time designator “5” generally aligned with the indicator 66. The control knob 56 arrangement of FIG. 4A could be accomplished by a user when initially “setting” the roasting device 20 (FIG. 1A) for a roasting operation. As the controller 54 (FIG. 2) then prompts operation in a roasting mode (as described below), the control knob 56 is caused to incrementally rotate relative to the housing 30, aligning differing indicia 72 with the indicator 66. FIG. 4B reflects the control knob 56 at a later point in time during the roasting cycle, with the roast time designator “3” now generally aligned with the indicator 66. As user is thus provided with a visual indication of time remaining in the roasting cycle (e.g., the roasting cycle time has progressed from the initial time setting of “5” in FIG. 4A to the intermediate time of “3” in FIG. 4B). At a later point in time, controlled rotation of the control knob 56 relative to the housing 30 will progress to the arrangement of FIG. 3 in which the middle cycle designator “*” is generally aligned with the indicator 66. This arrangement visually conveys to a user that the roasting device 20 has completed a roasting operation and is now in a cooling mode. Finally, FIG. 4C illustrates an even later point in time, with the control knob 56 having been rotated such that the last cycle designator “*” is generally aligned with or beyond the indicator 66, conveying to the user that the roasting and cooling operations are complete.

Cycle mode can be indicated to a user in a number of other manners. For example, in some embodiments, the controller 54 (FIG. 2) is further configured to selectively generate differing visual effects at the indicator 66 via operation of the light source 59 (FIG. 2). With these constructions, the controller 54 can be programmed to prompt the light source 59, and thus the indicator 66 to generate a first visual effect in a roasting or heating mode (e.g., the light source 59 is prompted to emit a red colored light during a heating mode) and a second visual effect in a cooling mode (e.g., the light source 59 is prompted to emit a white colored light during a cooling mode).

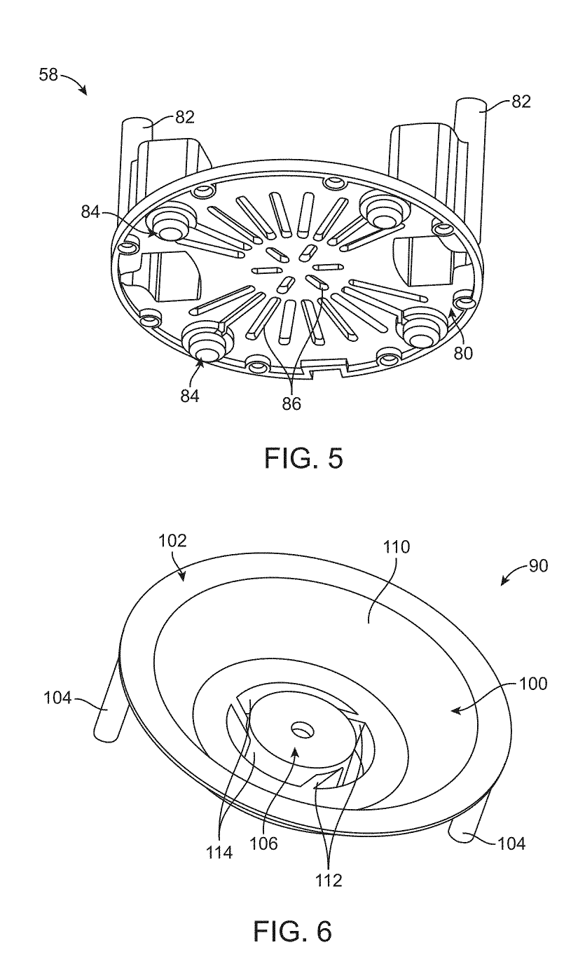

Returning to FIG. 2, the floor assembly 58 can assume various forms appropriate for supporting various other components of the base unit 22. In some embodiments, and with additional reference to FIG. 5, the floor assembly 58 includes or forms a platform 80, supports 82, and optional feet 84. The platform 80 is sized and shaped for mounting to the housing 30 (e.g., where the housing 30 has a cylindrical shape, the platform 80 can have a circular shape). The supports 82 project upwardly from the platform 80, and are configured for mounting to a corresponding component of the air flow assembly 60. The feet 84 project from an opposing, bottom surface of the platform 80 and may be formed of the same material as the floor assembly 58 or made as separate components of a different material (e.g., a material to improve or eliminate the ability of the roasting device 20 to slide relative to a surface on which it is placed). The feet 84 are configured for placement on a table top or other flat surface, supporting the platform 80 slightly above the surface. In some embodiments, the floor assembly 58 incorporates one or more features that facilitate air flow into base unit 22. For example, the platform 80 can form or define a plurality of slots or air intakes 86. Other air intake constructions are equally acceptable, as described in greater detail below. In other embodiments, the platform 80 or the floor assembly 58 as a whole can be integrally formed with the housing segment 42 as a single, homogenous structure.

With specific reference to FIG. 2, the air flow assembly 60 is generally configured to support the heating element 50 and the fan assembly 52, and provides an air flow region within which the roasting chamber unit 24 (FIG. 1A) is located in the assembled state. In some embodiments, the air flow assembly 60 includes a shroud 90, a hub 92, and a guide ring 94. With additional reference to FIG. 6, the shroud 90 forms or defines a shroud body 100, a flange 102, posts 104, and a coupling sleeve 106. The shroud body 100 has a cup-like shape, establishing an open region 110 (referenced generally in FIG. 6) at which the fan impeller 64 is received and can freely rotate upon final assembly. The flange 102 projects radially from an upper edge of the shroud body 100, establishing a surface for receiving the heating element 50 and the hub 92 as described below. The posts 104 project from the flange 102, and are each configured for connection to a respective one of the floor assembly supports 82. The coupling sleeve 106 is configured to receive and maintain the fan motor 62. As best seen in FIG. 6, spaced apart struts 112 interconnect the coupling sleeve 106 and the shroud body 100; gaps 114 are defined between the struts 112 that permit airflow into the open region 110 as described below. The shroud 90 can alternatively incorporate other formats or features that facilitate assembly within the base unit 22, support the heating element 50 and/or fan assembly 52, etc.

With specific reference to FIG. 2, the hub 92 has a generally cylindrical shape, forming or defining a collar 120, a cylindrical side wall 122, and a shoulder 124. The collar 120 is configured for assembly to or over the flange 102 of the shroud 90. The cylindrical side wall 122 projects from the collar 120 to define a cavity 126 (referenced generally). The shoulder 124 extends radially inwardly from the cylindrical side wall 122 opposite the collar 120, and establishes an opening 128 to the cavity 126 (with the opening 128 having a diameter less than an inner diameter of the cylindrical side wall 122). The hub 92 can alternatively other shapes, formats or features that facilitate assembly to the shroud 90 and define the cavity 126, including elimination of the shoulder 124 such that the opening 128 extends to an inner diameter of the side wall 122).

The guide ring 94 is generally configured for interface with the shoulder 124 of the hub 92, and includes or defines a ring body 130 and a partition 132. The ring body 130 is configured to nest within the opening 128 of the shoulder 124, and defines a channel 136 (referenced generally) that is sized and shaped in accordance with geometry features of the roasting chamber unit 24 (FIG. 1A) as described in greater detail below. In some embodiments, for example, the channel 136 can have a tapering diameter in longitudinal extension from the partition 132. The partition 132 projects radially outwardly from the ring body 130, and is, in some embodiments, configured for mounting to the housing 30 as described below.

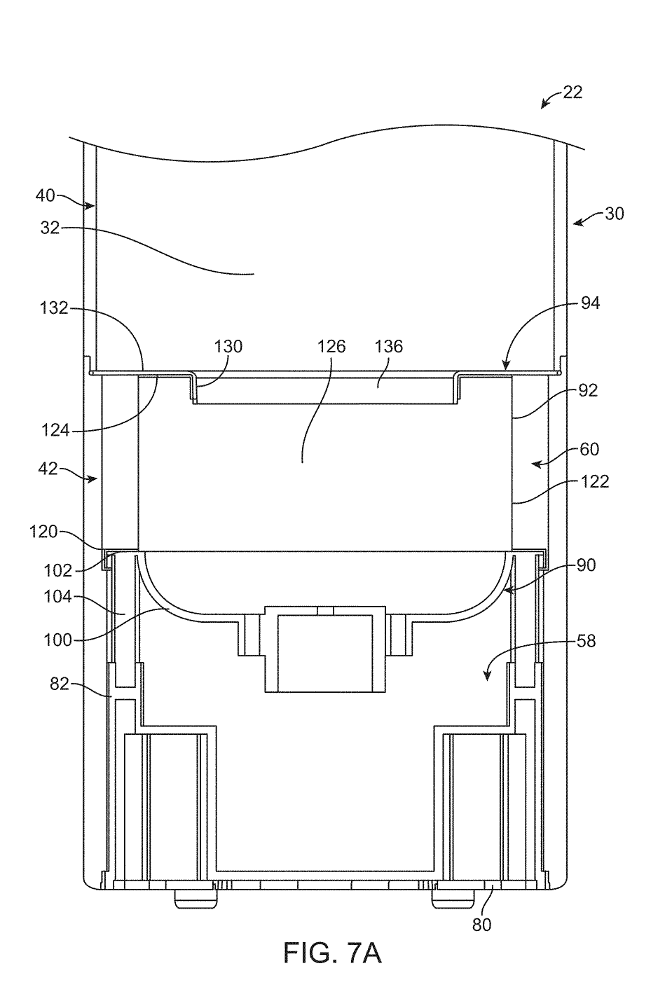

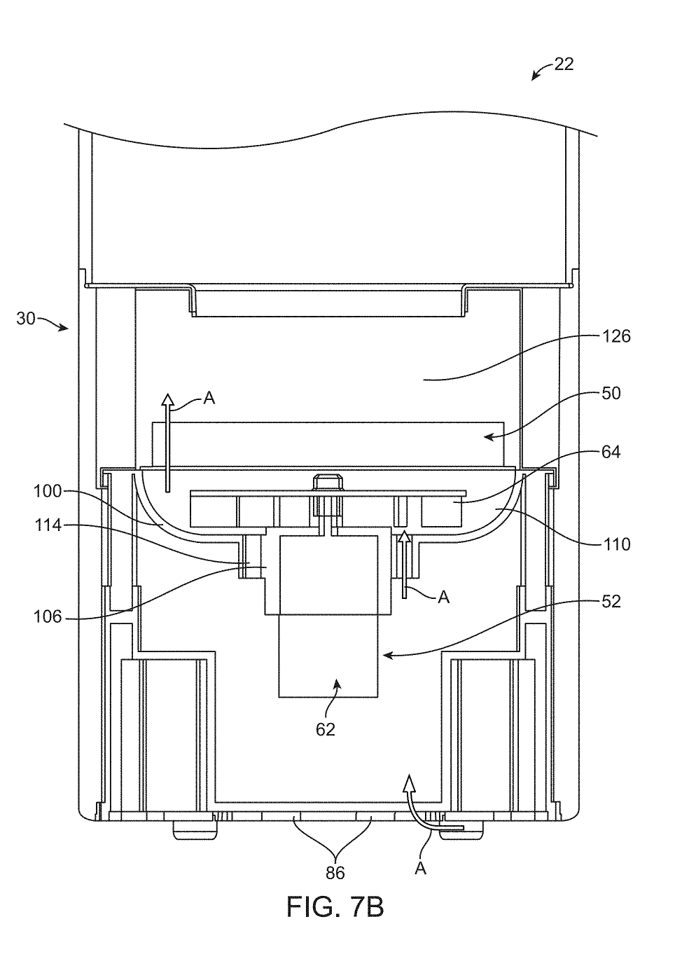

Final construction of the air flow assembly 60 relative to the housing 30 and the floor assembly 58 is provided in FIG. 7A. For ease of understanding, other components (e.g., the heating element 50 and the fan assembly 52) of the base unit 22 are omitted from the view. The second housing segment 42 is assembled to the platform 80. The shroud 90 is connected to the floor assembly 58 via coupling of the posts 104 to respective ones of the supports 82. The hub 92 is connected to the shroud 90 via mounting of the collar 120 over the flange 102. The guide ring 94 is arranged over the hub 92, with the ring body 130 nested within the opening 128 (best seen in FIG. 2). The partition 132 is supported by either or both of the shoulder 124 of the hub 92 and the second housing segment 42. Finally, the first housing segment 40 is mounted to the second housing segment 42. With this arrangement, the cavity 126 of the air flow assembly 58 is essentially bounded by the cylindrical side wall 122, the shoulder 124 and the shroud body 100. The channel 136 established by the guide ring 94 is open to the cavity 126, as well as to the isolation chamber 32 of the housing 30. Apart from the channel 136, the partition 132 serves as closed floor to the isolation chamber 32.

The cross-section of FIG. 7B is identical to that of FIG. 7A, except that the heating element 50 and the fan assembly 52 are now shown. The fan motor 62 is secured to the coupling sleeve 106, and the impeller 64 is rotatably disposed within the open region 110 of the shroud body 100. The heating element 50 is located within the cavity 126, in close proximity to the impeller 64. For reasons made clear below, with operation of the fan assembly 52, airflow (shown by arrows A in FIG. 7B) is drawn through the air intakes 86 and into the open region 110 via the gaps 114. In other embodiments, the air intakes 86 can be formed or located along a side of the base unit 22 (e.g., formed in the housing 30). The airflow A is further forced or directed to the heating element 50 and the cavity 126. Under circumstances where the heating element 50 is activated to generate heat, operation of the fan assembly 52 results in heated airflow within the cavity 126.

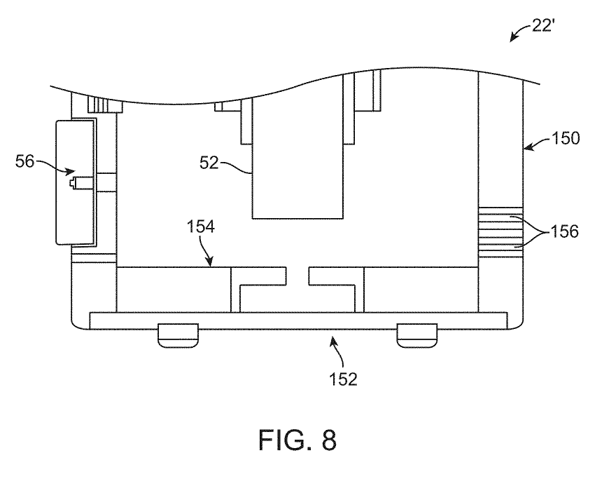

The roasting devices of the present disclosure can alternatively incorporate other constructions for delivering heated air to a cavity, and are not limited to the configuration and airflow patterns of FIG. 7B. For example, portions of an alternative embodiment base unit 22′ useful with the roasting devices of the present disclosure are shown in FIG. 8. The base unit 22′ can be highly akin to the base unit 22 (FIG. 1A) described above, and generally includes a housing 150, the fan assembly 52, the control knob 56, and a floor assembly 152, along with other components described above but not shown (e.g., a heating element, a controller, etc.). In addition, the base unit 22′ includes a Helmholtz chamber 154. The Helmholtz chamber 154 can have any configuration apparent to those of ordinary skill in the art, and provides noise attenuating properties appropriate for reducing noise emitted from the base unit 22′ during operation of the fan assembly 52. The Helmholtz chamber 154 can be mounted to or formed by the floor assembly 152. In yet other embodiments, differing noise reduction technology can be employed, (e.g., such as used in noise cancelling headphones). To facilitate airflow into the base unit 22′ with operation of the fan assembly 52, one or more air intakes 156 are defined through a thickness of the housing 150. The Helmholtz chamber 154 can also be utilized with the base unit 22 of FIG. 7B utilizing the air intakes 86 as previously described.

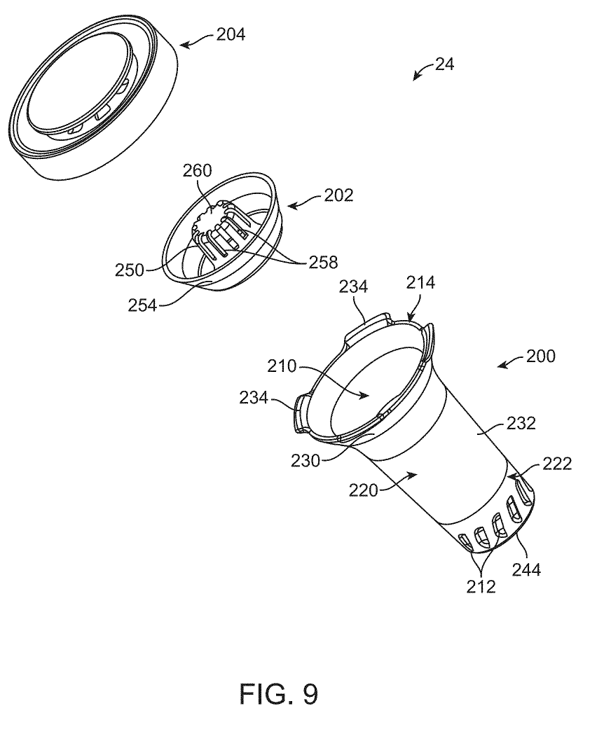

Returning to FIG. 1A, the roasting chamber unit 24 is generally sized and shaped for interfacing with geometry features of the base unit 22 as described above. With this in mind, one example of the roasting chamber unit 24 useful with the roasting devices of the present disclosure is shown in FIG. 9. The roasting chamber unit 24 includes a container 200, a filter 202, and a cap 204. In general terms, the container 200 establishes a roasting chamber 210 (referenced generally) within which consumable product (not shown) to be roasted (e.g., coffee beans) is maintained, along with one or more inlet ports 212 for reasons made clear below. A leading end 214 of the container 200 is open to the roasting chamber 210, and is sized to receive the filter 202. Finally, the cap 204 is configured to be selectively mounted to the container 200, and optionally to be selectively mounted to the base unit 22 (FIG. 1A).

In some embodiments, the container 200 includes or is formed by a tubular body 220 and a base 222. The tubular body 220 terminates at the leading end 214, and can be formed of a transparent or substantially transparent material that optionally exhibits low thermal transfer properties, such as glass. With this construction, product (not shown) contained in the roasting chamber 210 is visible through the tubular side wall 220. A leading portion 230 of the tubular body 220 can have a tapering geometry as shown, whereas a trailing portion 232 can have a shape akin to a right circular cylinder. Other shapes are also acceptable. In some embodiments, the tubular body 220 can further form or carry one or more features for mated connection with complimentary features provided with the cap 204. For example, with the non-limiting embodiment of FIG. 9, a plurality of circumferentially spaced tabs 234 are formed as outward extensions of or from the tubular body 220 at the leading end 214. Where provided, the tabs 234 are configured to interface with the corresponding features of the cap 204 as described below, it being understood that a number of other connection formats between the container 200 and the cap 204 are equally acceptable, such as threaded, magnetic, friction or other connection formats apparent to those of ordinary skill in the art.

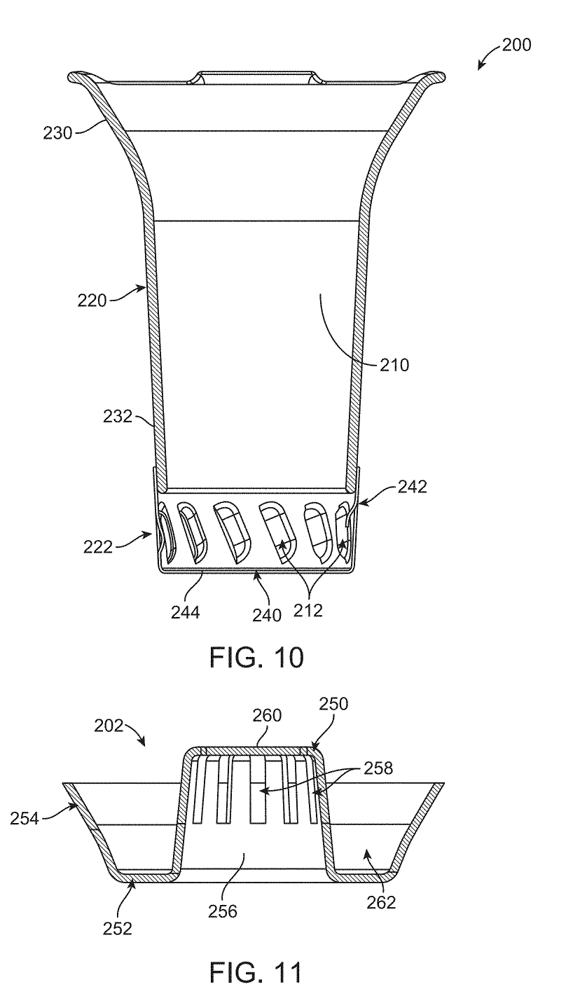

The base 222 can be formed apart from the tubular body 220, and thus can be formed of a non-transparent material in some embodiments. With additional reference to FIG. 10, the base 222 defines an end wall 240 and a side wall 242. The side wall 242 is configured for securement to the tubular body 220. The end wall 240 defines a trailing end 244 of the container 200, and in some embodiment is a continuous or uninterrupted structure, serving to close the roasting chamber 210. The inlet ports 212 are formed through a thickness of the side wall 242, and are open to the roasting chamber 210. In some embodiments, the inlet ports 212 can have an angular orientation relative to a longitudinal or central axis of the cup 200 (e.g., a primary axis of each of the inlet ports 212 is not parallel with central axis and is not perpendicular to a major plane of the end wall 240) such that airflow directed through the inlet ports 212 and into the roasting chamber 210 exhibits or experiences a swirling pattern. Other inlet port constructions are also envisioned that can provide alternative airflow patterns (e.g., lifting and swirling). FIG. 10 further reflects that in some embodiments, the side wall 242 has a slightly tapering diameter in extension from the tubular body 220 to the end wall 240. An angle or geometry of the taper corresponds with geometry features of the base unit 22 (FIG. 1A) and in particular of the guide ring channel 136 (FIG. 2) as made clear below. In alternate embodiments, the inlet ports can also be formed through the trailing wall 244 of the container 200 to promote a desired airflow pattern.

With specific reference to FIG. 9, the filter 202 is generally configured to facilitate the capture of particles, such as chaff, entrained within airflow established within the roasting chamber 210, and can have a wide variety of designs. In one embodiment, and with additional reference to FIG. 11, the filter 202 can include or define a head 250, a flange 252 and a skirt 254. The head 250 has a hollow construction, defining an outflow region 256. A plurality of slots 258 are formed through a wall thickness of the head 250 and are open to the outflow region 256. In some embodiments, at least a central portion of a top wall 260 of the head 250 is solid or continuous (e.g., the slots 258 to not extend across the top wall 260) for reasons made clear below. In other embodiments, one or more of the slots 258 can continue from the head 250 to the flange 252. Regardless, the slots 258 are each sized to prevent passage of the expected product to be roasted, while allowing other particles (e.g., chaff) to pass through. It will be recognized that air or fumes progressing to the filter 202 may also pass through the slots 258; in some optional embodiments, the cap 204 or the base unit 22 (FIG. 2) can include or carry a catalytic converter to minimize or eliminate fumes/smokes.

The flange 252 projects radially outwardly from the head 250 at a location opposite the top wall 260. The skirt 254 projects upwardly and radially outwardly from the flange 252 opposite the head 250. A geometry of the skirt 254 defines a tapered outer diameter, generally corresponding with a taper of the tubular body leading region 230 (FIG. 10). With this construction, the skirt 254 will nest against the leading region 230 upon insertion of the filter 202 into the container 200. In some embodiments, the flange 252 and the skirt 254 combine to form a bowl-like shape defining a collection zone 262. As described below, filtered particles can accumulate in the collection zone 262. Further, the bowl-like shape affords a user the ability to employ the filter 202 as a scoop for transferring product (not shown) from a supply of product into the roasting chamber 210.

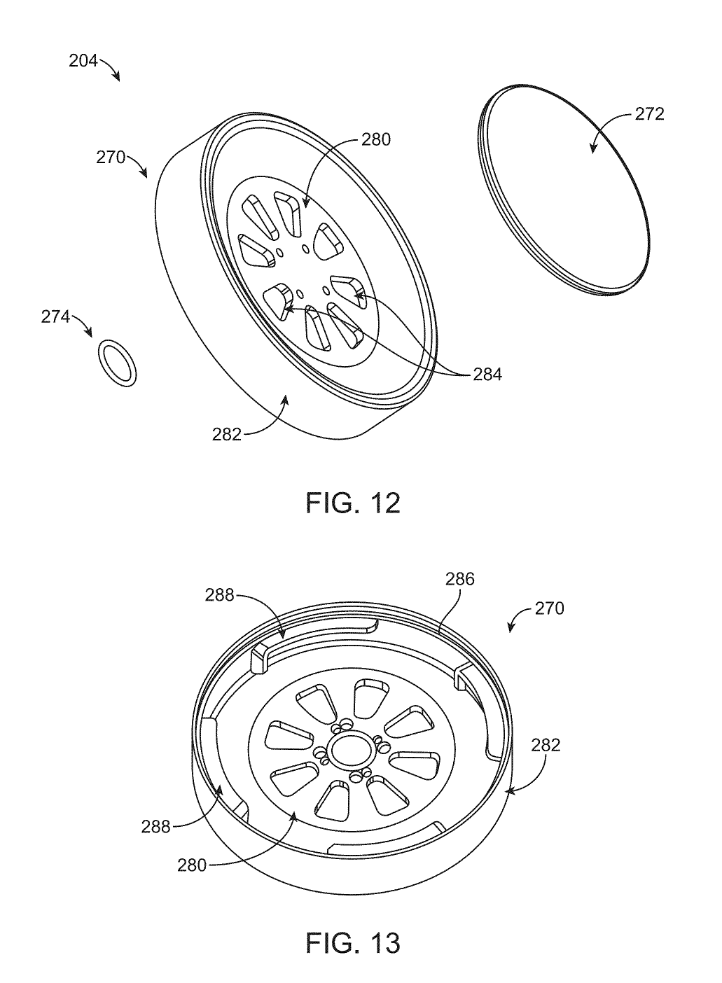

One embodiment of the cap 204 is shown in greater detail in FIG. 12, and can include a cap member 270, a cover 272, and an optional gasket 274. The cap member 270 includes or defines a central panel 280 and a rim 282. The central panel 280 defines a plurality of air vents 284 for reasons made clear below. Though not shown in the views, a screen or other filter media can be disposed across the air vents 284. The rim 282 circumscribes the central panel 280, and establishes an outer diameter commensurate with an outer diameter of the housing 30 (FIG. 2). In this regard, in some embodiments, the rim 282 is configured to promote selective engagement of the cap 204 with the housing 30, such as by forming a ledge 286 as shown in FIG. 13. Other engagement features can be provided or formed by the cap 204 apart from or in addition to the ledge 286. Regardless, FIG. 13 further reflects that in some embodiments, a plurality of ramps 288 are formed along an interior surface of the rim 282. The ramps 288 are generally configured to selectively receive and engage a corresponding one of the tabs 234 (FIG. 9) provided with the container 200 as described below. Other engagement formats can be incorporated into the cap 204 for selective mounting with the container 200 as mentioned above that may or may not include the ramps 288. The cap member 270 can have a single wall design; alternatively, the cap member 270 can be made from a dual-walled construction, allowing for vacuum insulation to keep the exterior wall(s) cooler during a roasting operation.

Returning to FIG. 12, the cover 272 is configured for assembly to the central panel 280, and simultaneously provides both a handle feature and a barrier or guide to airflow exiting the air vents 284 upon final assembly. The gasket 274, where provided, can be akin to an O-ring, and is mounted to an underside of the central panel 280.

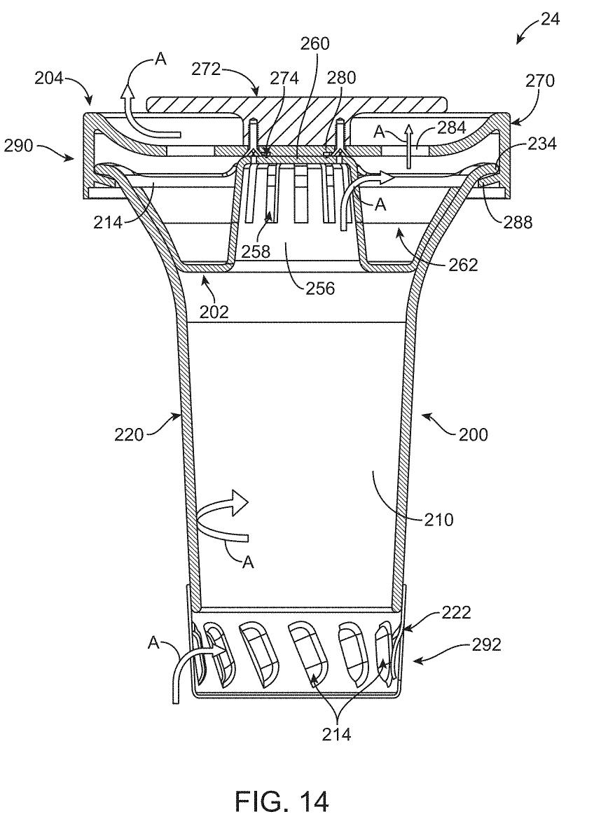

Final assembly of the roasting chamber unit 24 (including mounting of the cap 204 to the container 200) is shown in FIG. 14. The filter 202 is initially inserted through the leading end 214 of the container 200, and is lodged or nested within the tubular body 220. The cap 204 is secured to the container 200, for example by a frictional interface between respective ones of the tabs 234 and the ramps 288. In this secured arrangement, the gasket 274 abuts the central panel 280 of the cap member 270 and the top wall 260 of the filter 202, ensuring that as the cap 204 is tightened on to the container 200, the filter 202 is forced and held against the tubular body 220. Upon final assembly, the roasting chamber unit 24 can be viewed as defining a leading region 290 (e.g., primarily defined by the cap 204) opposite a trailing region 292 (e.g., defined by the base 222). Airflow (represented by arrows “A” in FIG. 14) can enter the roasting chamber 210 via the inlet ports 212. Airflow A exits the roasting chamber 210 via the slots 258. Larger particles (e.g., chaff) may be partially filtered or removed from the exiting airflow at the filter 202, for example lodging within the outflow region 256. Regardless, as the airflow A exits the slots 258 and enters an open volume between the cap 204 and the filter 202, airborne particles (e.g., chaff) can be filtered or removed as the airflow A proceeds to and through the air vents 284 in the central panel 280, for example by the optional screen (not shown) or other filter media located over the air vents 284. The so-removed particles fall into the collection zone 262. In some alternative embodiments, one or more through holes (not shown) can be defined in the top wall 260 and open to the gap between the top wall 260 and the cap 204 to provide an additional path for the chaff to enter the collection zone 262. The cover 272 projects over the air vents 284 at a location longitudinally spaced from the central panel 280, serving to more widely disperse the exiting airflow A to the outside environment. Under circumstances where the exiting airflow A is at an elevated temperature, presence of the cover 272 minimizes the possibility of user inadvertently contacting a concentrated stream of extremely hot air.

During use, a roasting procedure begins with the roasting chamber unit 24 removed from the base unit 22 (FIG. 1A) (i.e., the product load/unload state of FIG. 1A). The user removes the cap 204 from the container 200, such as, for example, by rotating the cap 204 relative to the container 200 (and/or vice-versa). With additional reference to FIG. 13, with rotation of the cap 204, the tabs 234 slide along the corresponding ramp 288, eventually disengaging the ramps 288 and allowing complete removal of the cap 204 from the container 200. The filter 202 is also removed from the container 200, and desired quantity of consumable product (e.g., green coffee beans) is loaded into the roasting chamber 210. In this regard, the filter 202 can optionally be employed to measure and load the desired amount of product to be roasted. The filter 202 is then placed back into the container 200 and is secured in place by the cap 204. The roasting chamber unit 24 is now prepared for assembly to the base unit 22.

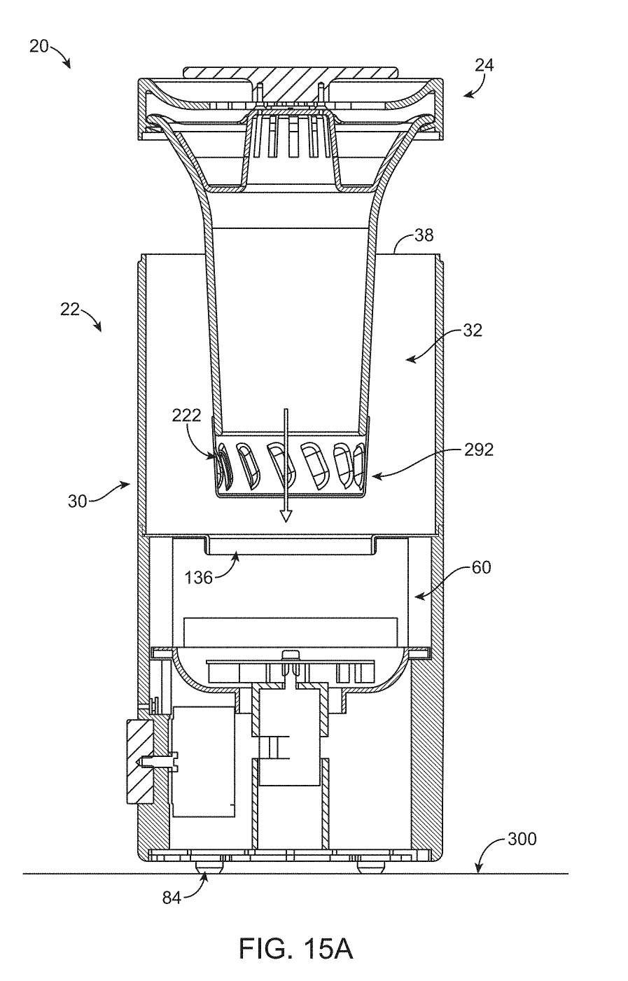

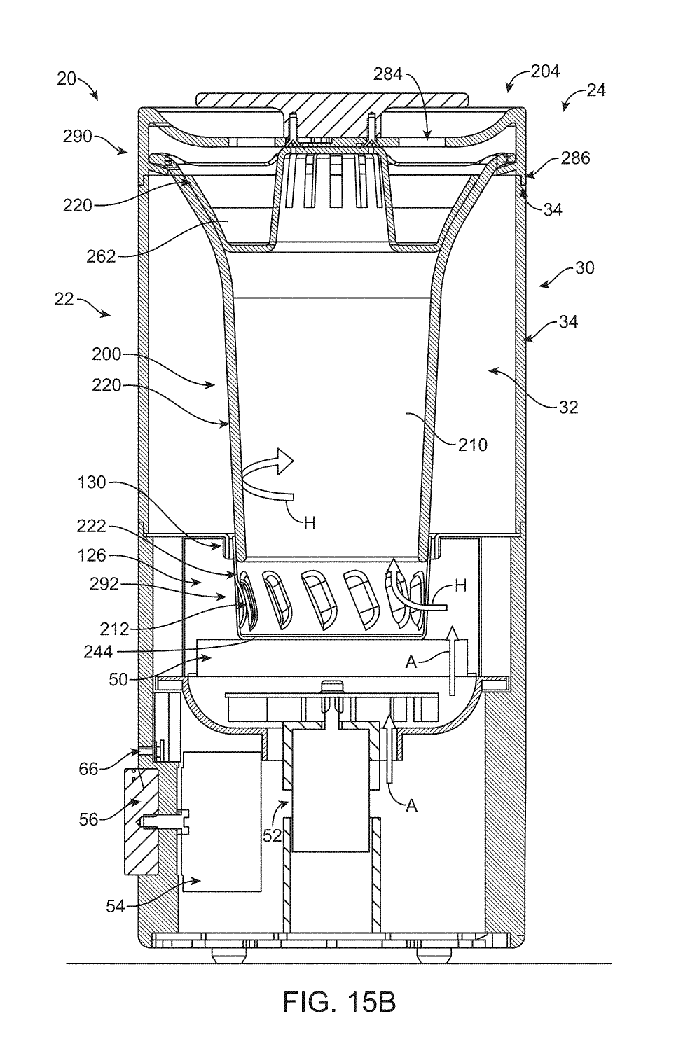

FIG. 15A reflects an initial stage of insertion of the roasting chamber unit 24 into the base unit 22. As a point of reference, the base unit 22 is appropriately sized for in-home placement and operation, arranged in the upright position of FIG. 15A at any commonly-available surface 300 (e.g., table top, counter top, etc.). The feet 84 are placed on the surface 300, and serve to support the base unit 22 relative to the surface 300. In the arrangement of FIG. 15A, the user has first aligned the trailing region 292 of the roasting chamber unit 24 with the opening 38 in the housing 30 and then begun directing the trailing region 292 into and through the isolation chamber 32. As shown, the trailing region 292 is poised for placement or insertion into the channel 136 of the airflow assembly 60.

Insertion of the roasting chamber unit 24 into the base unit 22 continues (in the direction indicated by an arrow in FIG. 15A), bringing the trailing region 292 into and then through the channel 136. In some embodiments, the corresponding tapered geometries of the base 222 and the channel 136 naturally aligns the base 222 within the channel 136, serving to guide the roasting chamber unit 24 to the assembled stated of FIG. 15B. In the assembled state, the leading region 290 of the roasting chamber unit 24 is engaged with the housing 30 to longitudinally support the roasting chamber unit 24 relative to the base unit 22 (e.g., engagement between the leading region 290 and the housing 30 prevents further downward insertion or movement of the roasting chamber unit 24 relative to the base unit 22 from the arrangement of FIG. 15B). In some embodiments, engagement between the roasting chamber unit 24 and the base unit 22 is achieved by an abutting interface between the support surface 34 of the base unit 22 and the ledge 286 of the cap 204. With the optional embodiments of FIG. 15B, an outer diameter of the cap 204 corresponds with an outer diameter of the housing 30 (at least at the upper-most end of the housing 30), providing the roasting device 20 with a clean, aesthetically pleasing appearance in the assembled state. Corresponding geometries of the base unit 22 and the roasting chamber unit 24 are such that in this supported position (dictated by engagement of the leading region 290 with the housing 30), the trailing region 292 (and in particular the inlet ports 212) is located within the cavity 126. Further, the trailing end 244 is located and maintained slightly above the heating element 50. Thus, the roasting chamber unit 24 is longitudinally supported relative to the base unit 22 by an interface location longitudinally spaced from the trailing end 244 of the roasting chamber unit 24. In some embodiments, the corresponding tapered geometries of the base 222 and the channel 136 (FIG. 15A) is such that in the assembled state, the base 222 contacts or nearly contacts the ring body 130. Interface or near interface between the base 222 and the ring body 130 can be akin to a seal or near seal, serving to limit airflow from the cavity 126 and into the isolation chamber 32. Regardless, at least a portion of the roasting chamber unit 24 is located and maintained within the isolation chamber 32 in the assembled state. For example, at least a majority of the tubular body 220 held within the isolation chamber 32, radially spaced (interiorly) from the housing 30.

Once the roasting chamber unit 24 fully inserted into the base unit 22, the user activates the roasting device 20 by turning the control knob 56 to the desired roasting time (e.g., as described above with respect to FIG. 4A, the control knob 56 is rotated by the user to bring the desired indicia 72 into alignment with the indicator 66). In other examples, the base unit 22 can provide an additional switch that is first actuated to an “on” position, followed by user operation of the control knob 56. In response to this user prompt, the controller 54 operates, for example in accordance with pre-programmed logic or algorithms, to activate the heating element 50 and the fan assembly 52. In some optional embodiments, the base unit 22 is configured to sense the presence of the roasting chamber unit 24 (and/or product loaded therein) and accompanying circuitry and logic to determine the available functionality of the base unit 22 based on the presence of the roasting chamber unit 24 (and/or product loaded therein).

Operation of the fan assembly 52 draws in airflow A through the air intakes 86 and forces the airflow A toward the heating element 50. The heating element 50, in turn, heats the airflow A, resulting in heated airflow H being forced or directed into the cavity 126. The heated airflow H progress through the inlet ports 212 and into roasting chamber 210. The so-directed heated airflow H can have a swirling flow pattern within the roasting chamber 210 due to a configuration of the inlet ports 212 as described above, as well as the generally cylindrical shape of the container 200. The heated airflow H within the roasting chamber 210 both activates the roasting process and stirs the coffee beans (or other consumable product) as they are heated to achieve a more even roast across all product contained within the roasting chamber 210.

As the roast progresses, an optional timer feature or function of the controller 54 counts down to a cooling cycle. As described above with respect to FIGS. 4B and 4C, the controller 54 can be programmed or include logic components that prompt incremental rotation of the control knob 56 relative to the indicator 66, providing the user with a visual indication of remaining roast time and/or initiating of the cooling cycle. Once the roast time has elapsed, the controller 54 operates to deactivate the heating element 50 while continuing to operate the fan assembly 52. The controller 54 continues to operate the fan assembly 52 for a fixed time cooling cycle in which room temperature air is supplied to the roasting chamber 210 to stop the roasting cycle and cool down the roasting chamber unit 24.

Throughout the roasting and cooling cycles, chaff (or other particles) from the coffee beans (or other product) contained by the roasting chamber unit 24 is carried out of the top of the roasting chamber 210 by the airflow. The entrained particles are filtered from the exiting airflow as described above (e.g., screen or other filter media disposed over the air vents 284) and accumulate within the collection zone 262 of the filter 202. With optional embodiments in which the housing 30 includes the first housing segment 34 formed of a transparent material and the tubular body 220 is formed of a transparent material, a user can visually confirm a roasting status of the product within the roasting chamber 210 while the roasting chamber unit 24 is assembled to the base unit 22. Further, with optional embodiments in which the housing 30 encircles, but is radially spaced from, the tubular body 220, a user cannot inadvertently touch the tubular body 220 during the roasting process, and heat transfer from the tubular body 220 to the housing 30 is attenuated.

After the roasting chamber unit 24 has been cooled, it can be removed from the base unit 22. The cap 204 is then removed from the container 200, followed by withdrawal of the filter 202. Chaff and other collected particles can be then be removed from the filter 202. Finally, the roasted product is dispensed from the container 200, and the roasting device 20 is then available for another roasting operation.

While the roasting device 20 has been described as including a single-setting type heating element, in other embodiments a heating element or heating device with variable settings can be employed. The corresponding roasting device can be configured to operate at a pre-set temperature level for an entire roast period, or could operate to vary the temperature at different stages of the roasting cycle either automatically or through manual intervention by the user. In related embodiments, a changeable temperature setting could allow for finer control of the roasting profile as desired by a user, which in turn can generate different flavors from the same batch of green coffee beans. In yet other embodiments, an alternative heating method (i.e., differing from the heating element 50 arrangement described above) can be employed. For example, conductive heat transfer could be utilized, providing direct contact with some heating element in the base unit that heats the roasting chamber unit base and transfers that heat to the coffee beans (or other contained product). Radiant heat transfer could also be utilized, with a heating element located in the base unit that heats the roasting chamber unit base and transfers heat to the coffee beans.

With optional embodiments in which the roasting device 20 automatically operates to perform a cooling cycle immediately following a roasting cycle, room temperature air can be utilized as described above. In other embodiments, the roasting device can be configured to incorporate or provide more active cooling. For example, a cooling device, either chilled water/gas or thermoelectric, can be provided with the roasting device, operating to change or cool the temperature of airflow directed into the roasting chamber 210 and thus more quickly cool the roasted product. Alternatively or in addition, the roasting device can include a built-in water sprayer, operable to spray a mist of water into the roasting chamber 210 during the cooling cycle. This would allow for more rapid heat transfer from the coffee bean (or other product) to the surrounding air and therefore stop the roasting process more quickly.

While some embodiments of the roasting devices described above utilize the controller 54 programmed to automatically perform the roasting and cooling cycle in a pre-determined fashion in response to user actuation of the control knob 56, in other embodiments roasting control can be effectuated in other fashions. For example, the roasting device can be configured such that the entire roasting process is controlled by a smartphone/tablet app, computer program or cloud-based web program. This could allow for automatic logging of previous roasts, user-inputted notes and feedback, and social connectivity, either through the specific platform or by integrating with other social media platforms. These social platforms can also provide the user with professionally developed roaster setting recommendations or downloadable roasting profiles for the particular product to be roasted.

In addition, or as an alternative, to formation of a swirling airflow pattern within the roasting chamber 210 to stir or mix the contained coffee beans during the roasting process, in other embodiments of the present disclosure the roasting device is configured to provide direct mechanical agitation. For example, an auger, system of paddles, etc., can be included.

While the roasting device 20 has been described as including a single setting-type fan assembly (i.e., the fan assembly 52), in other embodiments a fan assembly with variable settings can be employed. The corresponding roasting device can be configured to operate the variable setting fan assembly at a pre-set fan speed level for an entire roast period, or to vary the fan speed at different stages of the roasting cycle either automatically or through manual intervention by the user.

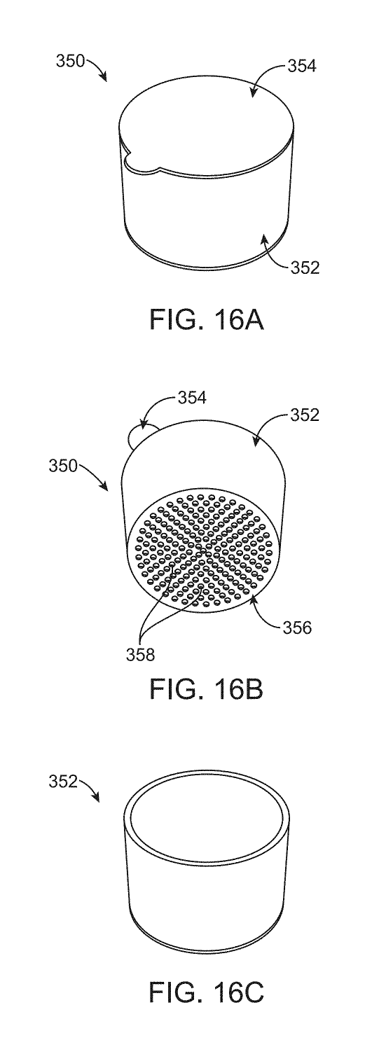

The roasting devices of the present disclosure can further include one or more cartridges pre-packaged with green coffee beans (or other consumable product). One example of a cartridge 350 useful with the roasting devices of the present disclosure is shown in FIGS. 16A and 16B, and includes a container 352 and a cover 354. The container 352 defines an internal volume (hidden) within which a volume of product (not shown) is stored. The container 352 is sized and shaped to fit within the roasting chamber unit 24 (FIG. 1A). The cover 354 extends across the container 352 to close off the internal volume. In some embodiments, the cover 354 is removably sealed to the container 352, with a user removing the cover 354 prior to placement of the container 352 into the roasting chamber unit 24 (e.g., FIG. 16C illustrates the container 352 alone following removal of the cover 354). In other embodiments, the cover 354 can be constructed of a material that is partially or wholly consumable during a roasting process (e.g., the cover 354 is configured to be consumed by heat during the initial phases of the roasting process, allowing for expansion of the contained coffee beans). As best shown in FIG. 16B, the container 352 includes a floor 356. The floor 356 can optionally be constructed of a material that is partially or wholly consumable during a roasting process. In some embodiments, the floor 356 can incorporate or form a pattern of perforations 358 arranged to direct incoming airflow in a pattern that facilitates mixing of the contained beans. In other embodiments, the cartridge 350 can further include a second cover (not shown, but akin to the cover 354 described above) disposed over the floor 356 and covering the perforations 358 thus creating a fully sealed container. With these and related embodiments, the corresponding roasting chamber unit can be configured such that the container 352 effectively replaces the base 222 (FIG. 9).

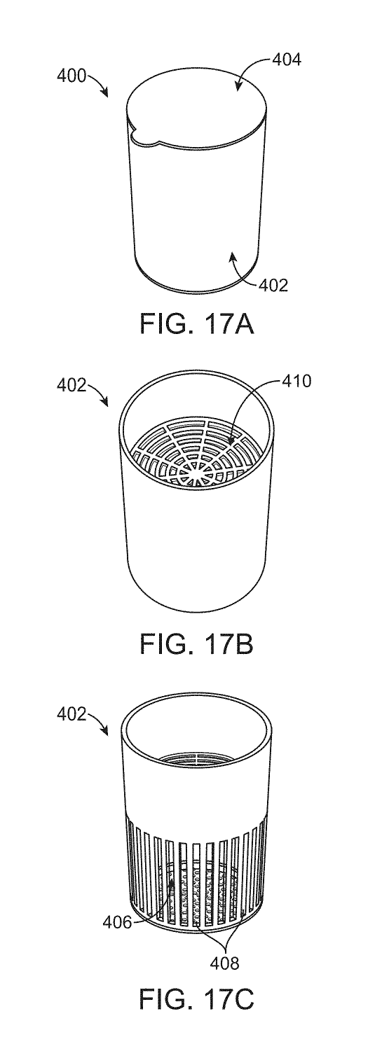

In related alternative embodiments, the roasting chamber unit can be akin to a removable, pre-packaged cartridge (e.g., obtained or purchased by a user with green coffee beans already loaded into the roasting chamber unit or cartridge. For example, another embodiment roasting chamber unit (or cartridge) 400 useful with or as part of roasting devices of the present disclosure is shown in FIG. 17A. The roasting chamber unit 400 includes a container 402 and a cover 404. The container 402 is configured (e.g., sized and shaped) for selective mounting to the corresponding base unit (not shown, but akin to the base unit 22 (FIG. 1A) described above) in accordance with the previous descriptions. With additional reference to FIGS. 17B and 17C, the container 402 defines a roasting chamber 406 (identified generally in FIG. 17C) within which green coffee beans (or other consumable product) is pre-loaded. One or more side windows 408 are defined through a wall thickness of the container 402 that allow a user to see the contained coffee beans (e.g. when evaluate progress of a roasting operation). A filter 410 (FIG. 17B) extends over the roasting chamber 406 as serves as a built-in chaff (or other particulate) filter. The cover 404 extends across the container 402. In some embodiments, the cover 404 is removably sealed to the container 402, with a user removing the cover 404 prior to placement of the container 402 into the base unit. In other embodiments, the cover 404 can be constructed of a material that is partially or wholly consumable during a roasting process (e.g., the cover 404 is configured to be consumed by heat during the initial phases of the roasting process, allowing for expansion of the contained coffee beans). The container 402 can optionally include or provide one or more frangible seals or connections that facilitate removal of the product following roasting.

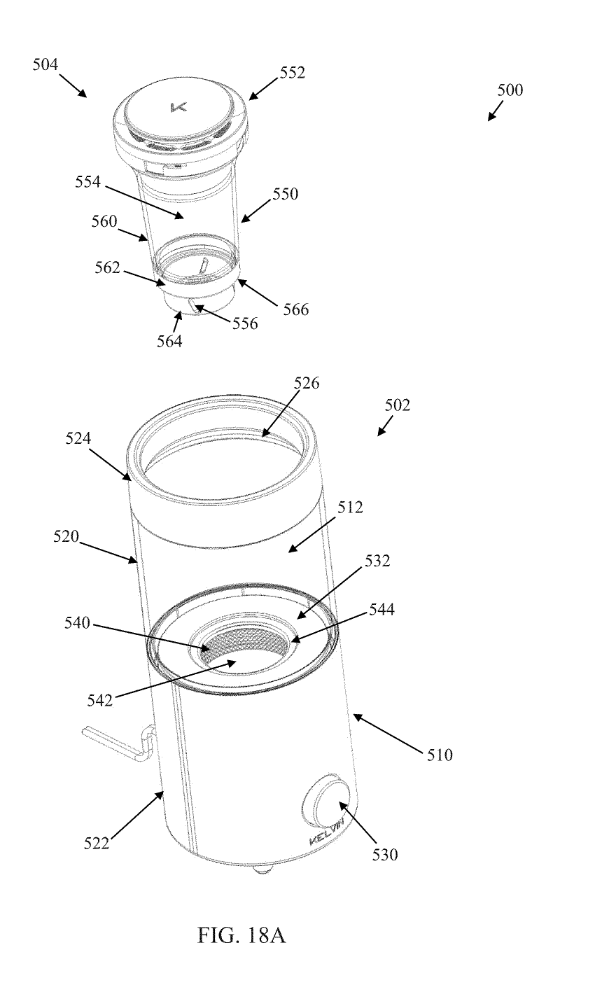

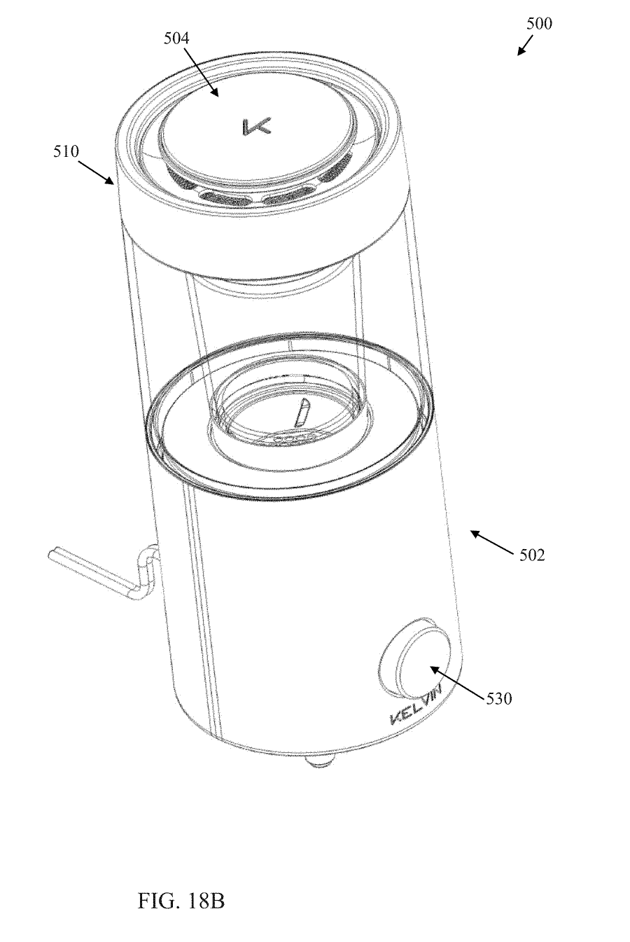

Another embodiment of a small batch roasting device 500 in accordance with principles of the present disclosure is shown in FIGS. 18A and 18B. The roasting device 500 is akin to the roasting device 20 (FIGS. 1A and 1B) described above, and includes a base unit 502 and a roasting chamber unit 504. The roasting chamber unit 504 is selectively mountable to the base unit 502, with a user readily transitioning the roasting device 500 between a product load/unload state (FIG. 18A) and an assembled state (FIG. 18B) as described above.

The base unit 502 can incorporate one or more of the features described above with respect to the base unit 22 (FIG. 1A), and includes a housing 510. The housing 510 is generally configured to maintain various components described below, as well as to establish an isolation chamber 512 (referenced generally in FIG. 18A) within which at least a portion of the roasting chamber unit 504 is located in the assembled state. With the non-limiting example of FIGS. 18A and 18B, the housing 510 is formed or defined by a first housing segment 520, a second housing segment 522, and a third housing segment 524. The first and second housing segments 520, 522 can be highly akin to the first and second housing segments 40, 42 (FIG. 1A), respectively, as described above. For example, the first housing segment 520 can be formed of a transparent or nearly transparent material (e.g., glass, plastic, etc.). The third housing segment 524 is mounted to the first housing segment 520 opposite the second housing segment 522, and defines a primary passageway 526 to the isolation chamber 512. In some embodiments, the third housing segment 524 can be formed of a material differing from that of the first housing segment 520 (e.g., the third housing segment 524 can be opaque whereas the first housing segment 520 can be transparent or nearly transparent).

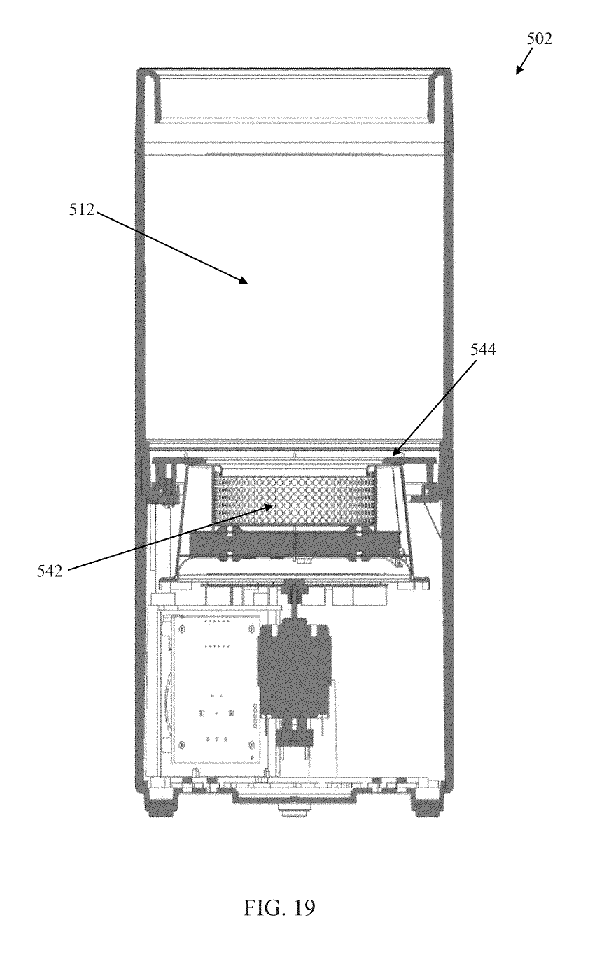

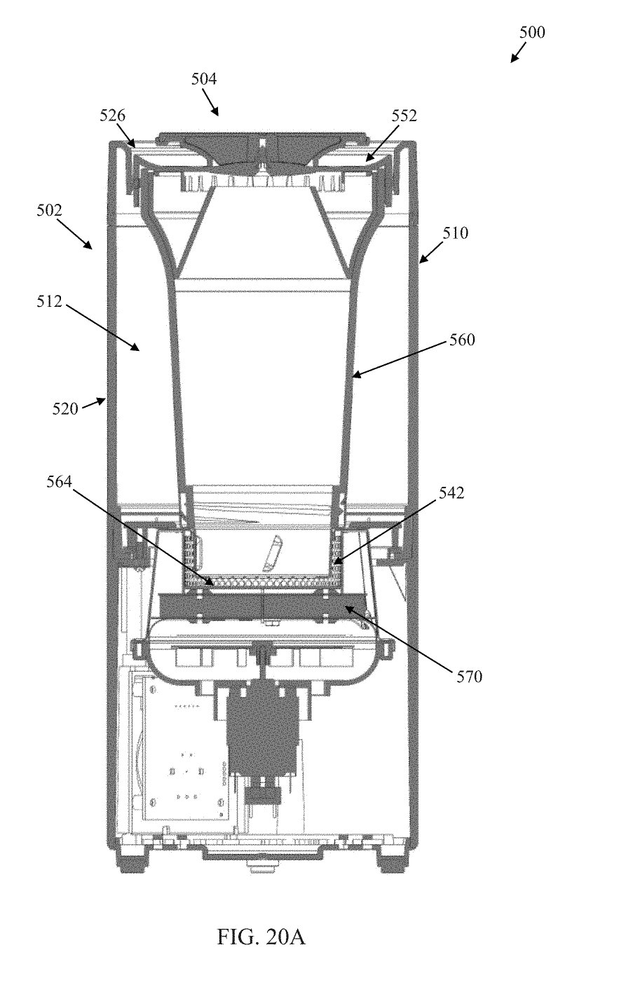

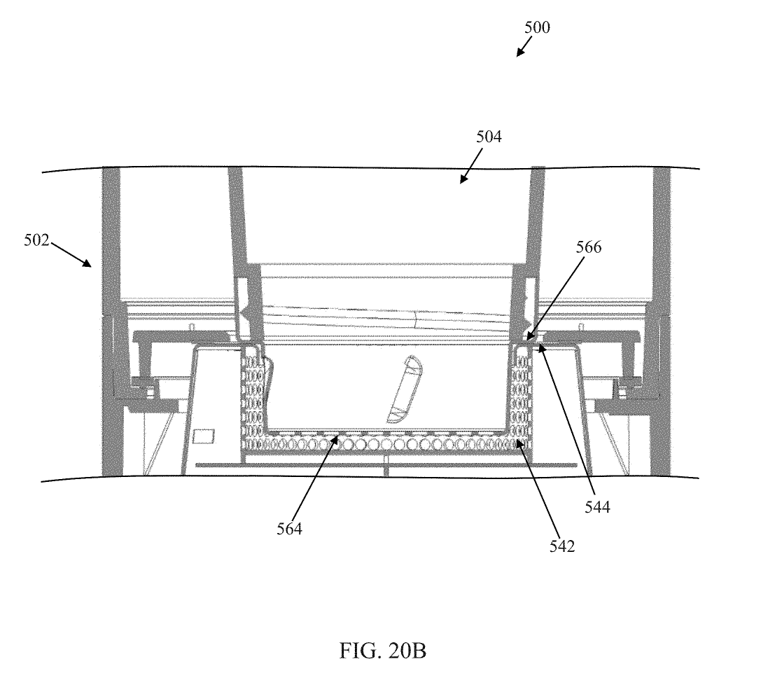

In addition to the housing 510, the base unit 502 can include various components akin to the description above such as a heating element (hidden, but shown in FIG. 20A), a fan assembly (hidden), a controller (hidden), a control knob 530, a floor assembly (hidden), and an air flow assembly 532 (referenced generally). The control knob 530 facilitates user control over operation of the roasting device 500 via interface with the controller as described below. The air flow assembly 532 can be akin to the air flow assembly 60 (FIG. 2), and generally includes a shroud 540 defining a cavity 542. The cavity 542 is open to the isolation chamber 512, and a support surface 544 is formed at the transition between the isolation chamber 512 and the cavity 542 as further shown in FIG. 19.

Returning to FIGS. 18A and 18B, operational control provided by the control knob 530 (and the controller) can assume various forms. In some non-limiting embodiments, the controller is programmed to perform various operations in response to user rotation of the control knob 530 and/or user pressing of the control knob 530. For example, in some embodiments, the control knob 530 is pressed to select either a temperature setting or a time setting, and the control knob 530 is rotated to set a particular temperature or a particular time. In some embodiments, the controller operates to prompt the display of temperature or time (or other information) to the user via a display (not shown) maintained within housing 510. The display can assume various forms, and in some embodiments is or includes an LED-type display that is visible through a thickness of the housing 510 when illuminated.

With specific reference to FIG. 18A, the roasting chamber unit 504 can be akin to the roasting chamber unit 24 (FIG. 1A), and is generally sized and shaped for interfacing with geometry features of the base unit 502. The roasting chamber unit 504 includes a container 550, a filter or collector (hidden), and a cap assembly 552. The container 550 establishes a roasting chamber 554 (referenced generally) and one or more inlet ports 556. The cap assembly 552 maintains the filter as assembled to the container 550. The container 550 can include a tubular body 560 and a base 562. The tubular body 560 can be formed of a transparent or nearly transparent material (e.g., glass). The base 562 is mounted to the tubular body 560 to define a trailing end 564 of the roasting chamber unit 504. Further, the base 562 (or optionally another component of the roasting chamber unit 504) defines a ledge 566 that is longitudinally spaced from the trailing end 564. For example, a diameter of the trailing end 564 is less than a diameter of the tubular body 560 at the intersection of the tubular body 560 and the base 562 to establish the ledge 566.

Assembly of the roasting chamber unit 504 to the base unit 502 (i.e., the assembled state) is shown in FIG. 20A. The roasting chamber unit 504 has been inserted through the passageway 526 (referenced generally), with the cap assembly 552 in contact with (or approximate contact with) the housing 510. As best seen in FIG. 20B, the ledge 566 of the roasting chamber unit 504 abuts the support surface 544 of the base unit 502 to longitudinally support the roasting chamber 504 relative to the base unit 502. Returning to FIG. 20A, in this supported position, the trailing end 564 of the roasting chamber unit 504 is located within the cavity 542, and is maintained above (or otherwise spaced from) components of the base unit 502, and in particular the heating element 570. At least a majority of the tubular body 560 is located in the isolation chamber 512; thus, with optional embodiments in which the first housing segment 520 and the tubular body 560 are transparent or nearly transparent, a user can visually see product contained within the roasting chamber unit 504 during a roasting operation.

Returning to FIGS. 1A and 1B, the roasting devices of the present disclosure can optionally be provided or incorporated into a product system that encompasses bean (or other consumable product) sourcing, ordering, and delivering. Packages of green coffee beans can be formatted to include recommended roasting setting on the packages, or incorporate sensing technology (e.g., scanners, RFID, etc.) that can be detected by the roasting device that would then be automatically pre-set to that recommended roasting time (also heat level and/or roast profile if those are adjustable features of the particular roasting device). These recommended setting could be previously determined by expert roasters, or through social media connectivity and community recommendation. Alternatively or in addition, these recommended setting could be provided as part of the optional application/program/web tool mentioned above. Additional, optional features of the product system can include the roaster device being integrated to other devices through Wi-Fi and/or Bluetooth, allowing for direct control from an app/program/web platform, and also enabling online inventory management. The roasting device can operate track the amount of beans a user has ordered and roasted, give recommendations based on previous roasts and user-inputted feedback, recommendations based on the broader community of connected roasters, and place orders for new green coffee beans automatically or on-demand. The orders could be of green coffee beans the user has roasted previously, part of curated recommendation system, or community-sourced recommendations/consensus.

As mentioned above, the roasting devices and systems of the present disclosure are not limited to the processing of coffee beans. Other consumable products are also acceptable. For example, the roasting device can be appropriate for roasting nuts. This could be through some combination of heating/cooling settings, as well as any required mechanical modifications to the roasting chamber unit components. The roasting device could be one part of an entire coffee ecosystem that not only roasts the coffee beans, but also grinds the beans, brews the coffee, and prepares the used coffee grounds and any packaging for composting. The grinder could have variable settings that can be user controlled or automatically controlled based on the beans, roast type and brewing method for example.

Although the present disclosure has been described with reference to preferred embodiments, workers skilled in the art will recognize that changes can be made in form and detail without departing from the spirit and scope of the present disclosure.

What is claimed is:

1. A small batch roasting device comprising:
a base unit including:
a housing defining an upper end, a lower end opposite the upper end, and an isolation chamber open to the upper end,
a heating element maintained within the housing,
a fan maintained within the housing between the heating element and the lower end,
a support surface longitudinally spaced from the lower end; and
a roasting chamber unit defining a roasting chamber, a leading region and a trailing region opposite the leading region, the trailing region terminating at a trailing end;
wherein the roasting device is configured to provide an assembled state in which at least a portion of the roasting chamber unit is disposed within the isolation chamber and the trailing region is proximate the heating element, the assembled state including the roasting chamber unit being supported relative to the base unit by an interface between the roasting chamber unit and the support surface of the base unit at a location longitudinally spaced from the trailing end.

2. The roasting device of claim 1, wherein the roasting device is further configured to provide a product load/unload state in which the roasting chamber unit is separated from the base unit, and further wherein an entirety of the roasting chamber unit is manually removable from the base unit in transitioning from the assembled state to the product load/unload state.

3. The roasting device of claim 2, wherein the trailing region terminates at a trailing end, and further wherein the assembled state includes the trailing end maintained spatially above the heating element.

4. The roasting device of claim 3, wherein the assembled state is characterized by the roasting chamber unit being longitudinally supported relative to the heating element solely by the interface between the roasting chamber unit and the support surface.

5. The roasting device of claim 4, wherein the roasting chamber unit includes:
a container including a tubular body and a base combining to define the roasting chamber, the roasting chamber being open at a leading end of the tubular body opposite the base; and
a cap selectively mounted over the leading end;
wherein the cap defines the leading region of the roasting chamber unit.

6. The roasting device of claim 5, wherein the assembled state includes at least one of the cap and the container abutting the support surface of the base unit.

7. The roasting device of claim 1, wherein the roasting chamber unit includes a container having a tubular body and a base combining to define the roasting chamber, and further wherein the assembled state includes the tubular body being transversely spaced from the housing.

8. The roasting device of claim 7, wherein the housing includes a first housing segment supported by a second housing segment, the second housing segment defining the lower end, and further wherein the first housing segment is a cylinder, and even further wherein the assembled state includes the tubular body disposed within, and radially spaced from, the first housing segment.

9. The roasting device of claim 8, wherein the first housing segment is transparent.

10. The roasting device of claim 9, wherein the first housing segment is glass.

11. The roasting device of claim 1, wherein the roasting chamber unit includes a cap, a container, and a filter.

12. The roasting device of claim 11, wherein the container includes a tubular body and a base, and further wherein the base includes an end wall and a side wall mounted to the tubular body, and further wherein the side wall projects from the end wall in a direction of the leading region.

13. The roasting device of claim 12, wherein the end wall is continuous, and further wherein the side wall defines a plurality of apertures open to the roasting chamber.

14. The roasting device of claim 11, wherein the container includes a tubular body defining a leading portion terminating at a leading end and a trailing portion extending from the leading portion in a direction opposite the leading end, and further wherein the leading portion defines an increasing outer diameter in longitudinal extension from the trailing portion to the leading end.

15. The roasting device of claim 14, wherein the filter is at least partially disposed within the leading portion upon final assembly.

16. The roasting device of claim 15, wherein the filter is removably assembled to the leading portion.

17. The roasting device of claim 15, wherein the cap extends over the filter upon final assembly.

18. The roasting device of claim 17, wherein the cap defines a plurality of vent holes.

19. The roasting device of claim 1, wherein the base unit further includes a single control knob carried by the housing, and further wherein the control knob is electronically connected to the heating element and the fan for prompting selective operation of the heating element and the fan.

20. The roasting device of claim 19, wherein the base unit further includes a controller programmed to control operation of the heating element and the fan in response to actuation of the control knob.
